(19) United States
(12) Patent Application Publication
(10) Pub. No.: US 2021/0034319 A1
(43) Pub. Date: Feb. 4, 2021

(54) MULTI-DEVICE EDITING OF 3D MODELS

(71) Applicant: APPLE INC., Cupertino, CA (US)

(72) Inventors: Norman N. Wang, Sarasota, CA (US); Benjamin B. Loggins, San Francisco, CA (US); Ross R. Dexter, Santa Clara, CA (US); Tyler L. Casella, Martinez, CA (US)

(21) Appl. No.: 17/071,269

(22) Filed: Oct. 15, 2020

Related U.S. Application Data
(63) Continuation of application No. PCT/US2019/028027, filed on Apr. 18, 2019.
(60) Provisional application No. 62/661,756, filed on Apr. 24, 2018.

(51) Int. Cl. G06F 3/14; G06T 19/20; G06F 3/0481; G06T 19/00; G06F 8/34; G06F 8/33; G06F 8/35

(52) U.S. Cl. CPC G06F 3/1454; G06T 19/20; G06F 3/04815; G06T 19/006; G06F 3/04842; G06F 8/33; G06F 8/35; G06T 2200/24; G06T 2219/024; G06F 8/34

(57) ABSTRACT

Various implementations disclosed herein include devices, systems, and methods that enable two or more devices to simultaneously view or edit the same 3D model in the same or different settings/viewing modes (e.g., monoscopically, stereoscopically, in SR, etc.). In an example, one or more users are able to use different devices to interact in the same setting to view or edit the same 3D model using different views from different viewpoints. The devices can each display different views from different viewpoints of the same 3D model and, as changes are made to the 3D model, consistency of the views on the devices is maintained.

### CROSS-REFERENCE TO RELATED APPLICATIONS

This application is a continuation of prior International Application No. PCT/US2019/028027, filed Apr. 18, 2019, which claims the benefit of U.S. Provisional Patent Application No. 62/661,756, filed Apr. 24, 2018, each of which is incorporated herein by reference in its entirety.

### TECHNICAL FIELD

The present disclosure generally relates to three dimensional (3D) models, and in particular, to systems, methods, and devices for viewing, creating, and editing 3D models using multiple devices.

### BACKGROUND

Computing devices use three dimensional (3D) models to represent the surfaces or volumes of real-world or imaginary 3D objects and scenes. For example, a 3D model can represent an object using a collection of points in 3D space, connected by various geometric entities such as triangles, lines, or curved surfaces and texture mappings that define surface appearances in the model. Some software development settings, including some integrated development settings (IDEs), facilitate the creation of projects that include 3D models. However, these software development settings do not provide sufficient tools for visualizing 3D models. Software development settings typically present a single view from a default or user-defined viewpoint of a 3D model. The developer is typically limited to viewing the 3D model from this viewpoint (e.g., as a 2D projection of the 3D model based on that viewpoint on a single flat monitor). It is generally time consuming and cumbersome for the developer to switch back and forth amongst alternative viewpoints, for example, by manually changing the viewpoint values (e.g., viewpoint pose coordinates, viewpoint viewing angle, etc.). In addition, existing software development settings provide no way for the developer to view a 3D model in multiple, different ways, e.g., monoscopically (e.g., as the 3D model would appear to an end-user using a single monitor device), stereoscopically (e.g., as the 3D model would appear to an end-user using a dual screen device such as a head-mounted device (HMD), in simulated reality (SR) (e.g., within a virtual coordinate system or as the 3D model would appear when combined with objects from the physical setting).

### SUMMARY

Various implementations disclosed herein include devices, systems, and methods that enable two or more devices to simultaneously view or edit the same 3D model in the same or different settings/viewing modes (e.g., monoscopically, stereoscopically, in SR, etc.). In an example, one or more users are able to use different devices to interact in the same setting to view or edit the same 3D model using different views from different viewpoints. The devices can each display different views from different viewpoints of the same 3D model and as changes are made to the 3D model, consistency of the views on the devices is maintained.

In some implementations, a method is performed at a first device having one or more processors and a computer-readable storage medium, such as device a desktop, laptop, tablet, etc. The method involves displaying, on the first device, a first user interface of a software development setting, such as an integrated development setting (IDE). The first user interface includes a first view of a 3D model based on a first viewpoint. For example, the first device can provide a monoscopic (i.e., single screen) view in the software development setting interface that includes a 2D projection of the object based on a selected viewpoint position and a default angle selected to provide a view centered on the center of the 3D model. A second user interface on a second device provides a second view of the 3D model based on a second viewpoint different from the first viewpoint. For example, where the second device is a head mounted device (HMD), the second viewpoint could be based on position or orientation of the HMD. The first device may send a data object corresponding to the 3D model directly or indirectly to the second device to enable the second device to display the second view. In some implementations, the 3D model is maintained on a server separate from the first device and second device, and both the first and second devices receive data objects and other information about the 3D model from the server and communicate changes made to the 3D object back to the server. In some implementations, one or both of the first and second devices are head mounted device (HMDs).

The method further receives, on the first device, input providing a change to the 3D object and, responsive to the input, provides data corresponding to the change. Based on this data, the second view of the 3D object on the second device is updated to maintain consistency between the 3D object in the first view and the second view. For example, if a first user changes the color of a 3D model of a table to white on the first device, the first device sends data corresponding to this change to the second device, which updates the second view to also change the color of the 3D model depicted on the second device to white.

Some implementations, as illustrated in the above example and elsewhere herein, thus enable simultaneous viewing or editing of a 3D object using different views on multiple devices. These implementations overcome many of the disadvantages of conventional, single-view software development setting settings. The implementations provide an improved user viewing editing experience as well as improve the efficiency of the communications and data storage.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example system in which two devices are linked to simultaneously view or edit the same 3D model in accordance with some implementations.

FIG. 2 illustrates the system of FIG. 1 in accordance with some implementations.

FIG. 3 illustrates a change made to the 3D model using the user interface on the first device of FIG. 2 in accordance with some implementations.

FIG. 4 illustrates the change made to the 3D model displayed on the user interface on the second device of FIG. 2 in accordance with some implementations.

FIG. 5 illustrates device components of an exemplary first device according to some implementations.

FIG. 6 illustrates device components of an exemplary second device according to some implementations.

FIG. 7 is a flowchart representation of a method for enabling multiple devices to interact to view or edit the same 3D model using different views from different viewpoints.

FIG. 8 is a flowchart representation of a method for establishing a link between a first device and a second device based on detecting the second device.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

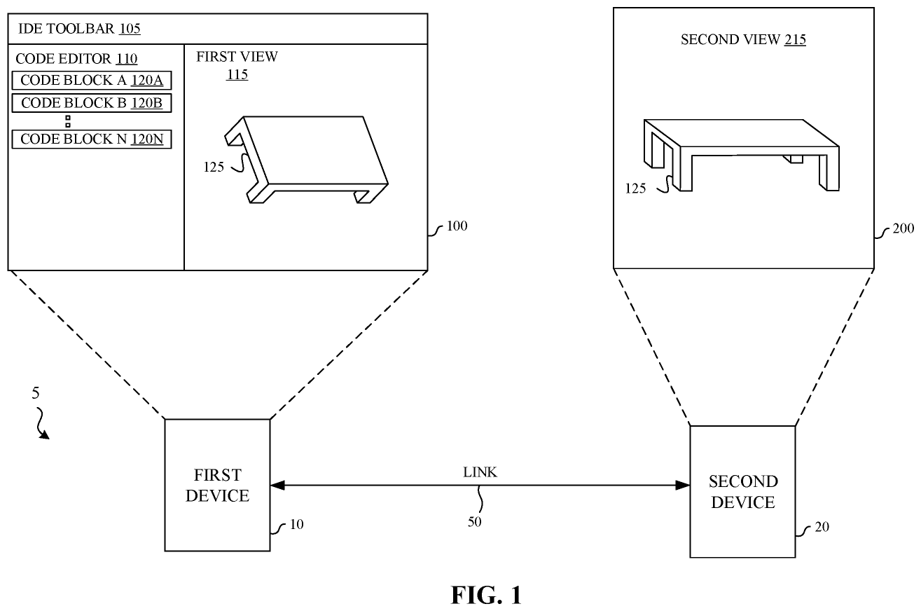

Referring to FIG. 1, illustrates an example system 5 in which two devices 10, 20 are linked via link 50 to simultaneously view or edit the same 3D model is presented. The first device 10 is linked to the second device 20 via a wired or wireless link including, but limited to, wired communications such as those that use a Universal Serial Bus (USB) cable/interface, a USB-C cable/interface, a THUNDERBOLT v1, v2, or v3 cable/interface, an IEEE 1394 cable/interface (e.g., FIREWIRE, i.LINK, LYNX), an IEEE 802.3x cable/interface (e.g., Ethernet), etc., and wireless communications such as those that use IEEE 803.11 transmissions (e.g., WiFi), IEEE 802.11 transmissions (e.g., WLAN), IEEE 802.16x transmissions (e.g., WiMAX), short-wavelength transmission (e.g., BLUETOOTH), IEEE 802.15.4 transmissions (e.g., ZIGBEE), GSM transmissions, ECMA-340 and ISO/IEC 18092 (e.g., near-field communication (NFC)), etc. The link 50 can be direct, i.e., without an intervening device or network node between the devices 10, 20. For example, the link 50 can involve directly connecting device 10 to device 20 via a single cable that plugs into each device or via Bluetooth communications between device 10 and device 20. The link 50 can be indirect, i.e., with one or more intervening devices or networks nodes. For example, the link 50 can connect device 10 to device 20 via communications sent via the Internet.

The first device 10 is configured to provide a user interface 100 of an integrated development setting (IDE) that includes an IDE toolbar 105, a code editor 110 with code blocks 120a-n, and a first view 115. Generally, the IDE provides an integrated tool for developing applications and other content that includes a 3D model. An IDE can include a source code editor, such as code editor 110, that developers use to create application and other electronic content that includes a 3D model. Without an IDE, a developer generally would need to write code in a text editor, access separate development tools, and separately compile, render, or run the code, for example, on separate applications and/or terminals. An IDE can integrate such development features into a single user interface. Typically, but not necessarily, an IDE user interface will include both tools for creating code (e.g., code editor 110) or parameters and for viewing what end-users of the created project will see (e.g., first view 115 displaying a rendering of a created 3D model 125 from a particular viewpoint).

The IDE toolbar 105 includes various tools that facilitate the creation and editing of an electronic content/3D model project. For example, an IDE can include a “New Project” menu item or the like for initiating directories and packages for a multi-file project, a “New File” menu items for creating new files for such a project, an editor window for creating code (e.g., Java, XML, etc.) for one or more of the files, a parameter tool for entering parameters, a build/run/render tool or the like for starting a compiler to compile the project, running a compiled application, or otherwise rendering content that includes the 3D model 125. The IDE can be configured to attempt to compile/render in the background what the developer is editing. If a developer makes a mistake (e.g., omitting a semicolon, typo, etc.), the IDE can present an immediate warning, for example, by presenting warning colors, highlights, or icons on the code, parameters, or within first view 115 on the 3D model 125.

3D model code or parameters can be input (e.g., via a keyboard, text recognition, etc.) to user interface 100 to define the appearance of the 3D model 125. For example, such code or parameters may specify that the appearance of the 3D model 125 or a portion of the 3D model 125 will have a particular color (e.g., white), have a particular texture (e.g., using the texture found in a particular file), have particular reflectance characteristics, have particular opacity/transparency characteristics, etc. Similarly, such code or parameters can specify the location, shape, size, rotation, and other such attributes of the 3D model 125 or portion of the 3D model 125. For example, such code or parameters may specify that the center of the 3D model 125 of a table is at location (50, 50, 50) in an x,y,z coordinate system and that the width of the 3D model 125 is 100 units.

Some IDEs include graphical editing windows, such as the window in which first view 115 is provided, that enable developers to view and graphically modify their projects. For example, a developer can resize a 3D model in his project by dragging one or more of the points or other features of the 3D model on the graphical editing window. The IDE makes a corresponding change or changes to the code blocks 120a-n or parameters for the 3D model 125 based on input received. The graphical editing window can be the same window that presents what the end-user will see. In other words, the graphical editing window can be used to present the compiled/rendered 3D model 125 and allow editing of the 3D model 125 via the compiled/rendered display of the 3D model 125 (e.g., via interactions within the first view 115).

Various implementations enable two or more devices such as devices 10, 20 to simultaneously view or edit the 3D model 125 in the same or different settings/viewing modes (e.g., monoscopically, stereoscopically, in SR, etc.). To enable the second device 20 to simultaneously view or edit the 3D model 125 the link 50 is established between the devices 10, 20.

In some implementations, the first device 10 provides the 3D model 125 to the second device 20 so that the second device 20 can display a second view 215 of the 3D model 125 that is different from the first view 115. For example, the viewpoint used to display 3D model 125 in the first view 115 on the first device 10 can differ from the viewpoint used to display the 3D model 125 in the second view 215 on the second device. In the example of FIG. 1, the viewpoint of the first view 115 is based on a different viewing position and viewing angle than the viewpoint of the second view 215. In one example, the viewpoint used for the first view 115 is based on a default or user specified position that is not dependent upon the position or orientation of the first device 10 in the real world while the viewpoint used for the second view 215 is dependent upon the position or orientation of the second device 20 in the real world. In this way, one or more users can simultaneously view the 3D model 125 from different viewpoints.

The first view 115 and second view 215 may be provided on devices 10, 20 in the same or different physical settings. A “physical setting” refers to a world that individuals can sense or with which individuals can interact without assistance of electronic systems. Physical settings (e.g., a physical forest) include physical objects (e.g., physical trees, physical structures, and physical animals). Individuals can directly interact with or sense the physical setting, such as through touch, sight, smell, hearing, and taste.

One or both of the first view 115 and second view 215 may involve a simulated reality (SR) experience. The first view 115 may use a first SR setting and the second view 215 may use a second SR setting that is the same as or different from the first SR setting. In contrast to a physical setting, an SR setting refers to an entirely or partly computer-created setting that individuals can sense or with which individuals can interact via an electronic system. In SR, a subset of an individual's movements is monitored, and, responsive thereto, one or more attributes of one or more virtual objects in the SR setting is changed in a manner that conforms with one or more physical laws. For example, a SR system may detect an individual walking a few paces forward and, responsive thereto, adjust graphics and audio presented to the individual in a manner similar to how such scenery and sounds would change in a physical setting. Modifications to attribute(s) of virtual object(s) in a SR setting also may be made responsive to representations of movement (e.g., audio instructions).

An individual may interact with or sense a SR object using any one of his senses, including touch, smell, sight, taste, and sound. For example, an individual may interact with or sense aural objects that create a multi-dimensional (e.g., three dimensional) or spatial aural setting, or enable aural transparency. Multi-dimensional or spatial aural settings provide an individual with a perception of discrete aural sources in a multi-dimensional space. Aural transparency selectively incorporates sounds from the physical setting, either with or without computer-created audio. In some SR settings, an individual may interact with or sense only aural objects.

One example of SR is virtual reality (VR). A VR setting refers to a simulated setting that is designed only to include computer-created sensory inputs for at least one of the senses. A VR setting includes multiple virtual objects with which an individual may interact or sense. An individual may interact or sense virtual objects in the VR setting through a simulation of a subset of the individual's actions within the computer-created setting, or through a simulation of the individual or his presence within the computer-created setting.

Another example of SR is mixed reality (MR). A MR setting refers to a simulated setting that is designed to integrate computer-created sensory inputs (e.g., virtual objects) with sensory inputs from the physical setting, or a representation thereof. On a reality spectrum, a mixed reality setting is between, and does not include, a VR setting at one end and an entirely physical setting at the other end.

In some MR settings, computer-created sensory inputs may adapt to changes in sensory inputs from the physical setting. Also, some electronic systems for presenting MR settings may monitor orientation or location with respect to the physical setting to enable interaction between virtual objects and real objects (which are physical objects from the physical setting or representations thereof). For example, a system may monitor movements so that a virtual plant appears stationery with respect to a physical building.

One example of mixed reality is augmented reality (AR). An AR setting refers to a simulated setting in which at least one virtual object is superimposed over a physical setting, or a representation thereof. For example, an electronic system may have an opaque display and at least one imaging sensor for capturing images or video of the physical setting, which are representations of the physical setting. The system combines the images or video with virtual objects, and displays the combination on the opaque display. An individual, using the system, views the physical setting indirectly via the images or video of the physical setting, and observes the virtual objects superimposed over the physical setting. When a system uses image sensor(s) to capture images of the physical setting, and presents the AR setting on the opaque display using those images, the displayed images are called a video pass-through. Alternatively, an electronic system for displaying an AR setting may have a transparent or semi-transparent display through which an individual may view the physical setting directly. The system may display virtual objects on the transparent or semi-transparent display, so that an individual, using the system, observes the virtual objects superimposed over the physical setting. In another example, a system may comprise a projection system that projects virtual objects into the physical setting. The virtual objects may be projected, for example, on a physical surface or as a holograph, so that an individual, using the system, observes the virtual objects superimposed over the physical setting.

An augmented reality setting also may refer to a simulated setting in which a representation of a physical setting is altered by computer-created sensory information. For example, a portion of a representation of a physical setting may be graphically altered (e.g., enlarged), such that the altered portion may still be representative of, but not a faithfully-reproduced version of the originally captured image(s). As another example, in providing video pass-through, a system may alter at least one of the sensor images to impose a particular viewpoint different than the viewpoint captured by the image sensor(s). As an additional example, a representation of a physical setting may be altered by graphically obscuring or excluding portions thereof.

Another example of mixed reality is augmented virtuality (AV). An AV setting refers to a simulated setting in which a computer-created or virtual setting incorporates at least one sensory input from the physical setting. The sensory input(s) from the physical setting may be representations of at least one characteristic of the physical setting. For example, a virtual object may assume a color of a physical object captured by imaging sensor(s). In another example, a virtual object may exhibit characteristics consistent with actual weather conditions in the physical setting, as identified via imaging, weather-related sensors, or online weather data. In yet another example, an augmented reality forest may have virtual trees and structures, but the animals may have features that are accurately reproduced from images taken of physical animals.

In some implementations, the devices 10, 20 are each configured with a suitable combination of software, firmware, or hardware to manage and coordinate a simulated reality (SR) experience for the user. Many electronic systems enable an individual to interact with or sense various SR settings. One example includes head mounted systems. A head mounted system may have an opaque display and speaker(s). Alternatively, a head mounted system may be designed to receive an external display (e.g., a smartphone). The head mounted system may have imaging sensor(s) or microphones for taking images/video or capturing audio of the physical setting, respectively. A head mounted system also may have a transparent or semi-transparent display. The transparent or semi-transparent display may incorporate a substrate through which light representative of images is directed to an individual's eyes. The display may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one implementation, the transparent or semi-transparent display may transition selectively between an opaque state and a transparent or semi-transparent state. In another example, the electronic system may be a projection-based system. A projection-based system may use retinal projection to project images onto an individual's retina. Alternatively, a projection system also may project virtual objects into a physical setting (e.g., onto a physical surface or as a holograph). Other examples of SR systems include heads up displays, automotive windshields with the ability to display graphics, windows with the ability to display graphics, lenses with the ability to display graphics, headphones or earphones, speaker arrangements, input mechanisms (e.g., controllers having or not having haptic feedback), tablets, smartphones, and desktop or laptop computers.

In one example, the first view 115 provides a VR viewing mode that displays the 3D object in a VR coordinate system without real world content while the second view 215 provides an MR viewing mode that displays the 3D object in a real world coordinate system with real world content. Such an MR viewing mode includes visual content that combines the 3D model with real world content. MR can be video-see-through (e.g., in which real world content is captured by a camera and displayed on a display with the 3D model) or optical-see-through (e.g., in which real world content is viewed directly or through glass and supplemented with displayed 3D model). For example, a MR system may provide a user with video see-through MR on a display of a consumer cell-phone by integrating rendered three-dimensional (“3D”) graphics into a live video stream captured by an onboard camera. As another example, an MR system may provide a user with optical see-through MR by superimposing rendered 3D graphics into a wearable see-through head mounted display (“HMD”), electronically enhancing the user's optical view of the real world with the superimposed 3D model.

In some implementations both of the devices 10, 20 provide an MR view of the 3D object 125. In one example, each device 10, 20 displays a view of the 3D object 125 that includes different real world content depending upon the real world content surrounding or otherwise observed by the respective device. Each of the devices 10, 20 is configured to use images or other real world information detected using its own camera or other sensor. In some implementations, to provide the MR viewing mode, the devices 10, 20 use at least a portion of one or more camera images captured by a camera on the respective device 10, 20. In this example, each device 10, 20 provides a view using the real world information surrounding it. This dual MR viewing mode implementation enables the one or more users to easily observe the 3D model 125 in multiple and potentially different MR scenarios.

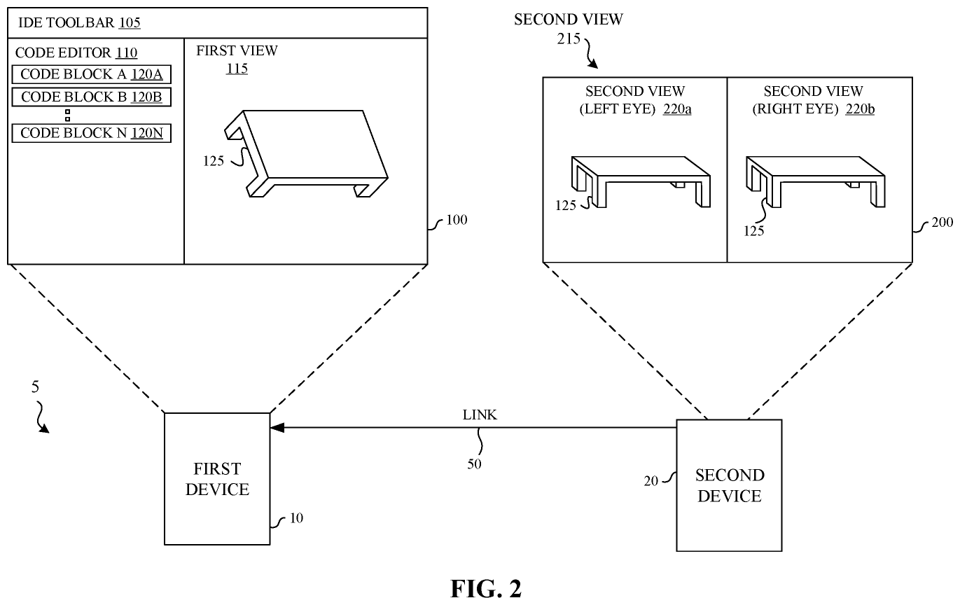

FIG. 2 illustrates the second user interface 200 including a second view 215 that provides a stereoscopic viewing mode with a second view left eye portion 220a and a second view right eye portion 220b. The second view left eye portion 220a includes a view of the 3D model 125 for the left eye and the second view right eye portion 220b includes a view of the 3D model 125 for the right eye. The viewpoints used to render the 3D model 125 for the left eye and right eye can be slightly different. For example, the relative positions of the 3D model 125 can be determined by projecting the 3D model 125 and offsetting them relative to one another based on an expected or actual distance between the user's eyes.

In some implementations involving an HMD or other movable device, the viewpoint used in providing the second view 215 is based upon the position or orientation of the second device 20. Thus, as the user moves his or her body or head and the position and orientation of the second device 20 changes, the viewpoint used to display the 3D model 125 in the second view 215 also changes. For example, if the user walks around, the user is able to change his or her viewpoint to view the 3D model 125 from its other sides, from closer or farther away, from a top-down observation position and angle, from a bottom-up observation position and angle, etc.

In some implementations, the second view 215 is provided by a head-mounted device (HMD) that a user wears. Such an HMD may enclose the field-of-view of the user. An HMD can include one or more screens or other displays configured to display the 3D model. In the example of FIG. 2, the HMD includes two screens/displays, one for the left eye and one for the right eye. In some implementations, an HMD includes one or more screens or other displays to display the 3D model with real world content that is in a field-of-view of the user. In some implementations, the HMD is worn in a way that one or more screens are positioned to display the 3D model with real world content in a field-of-view of the user.

In some implementations, the second device 20 is a handheld electronic device (e.g., a smartphone or a tablet) configured to present the 3D model 125. In some implementations, the second device 20 that provides the second view 215 is a chamber, enclosure, or room configured to present the 3D model 125 in which the user does not wear or hold the device.

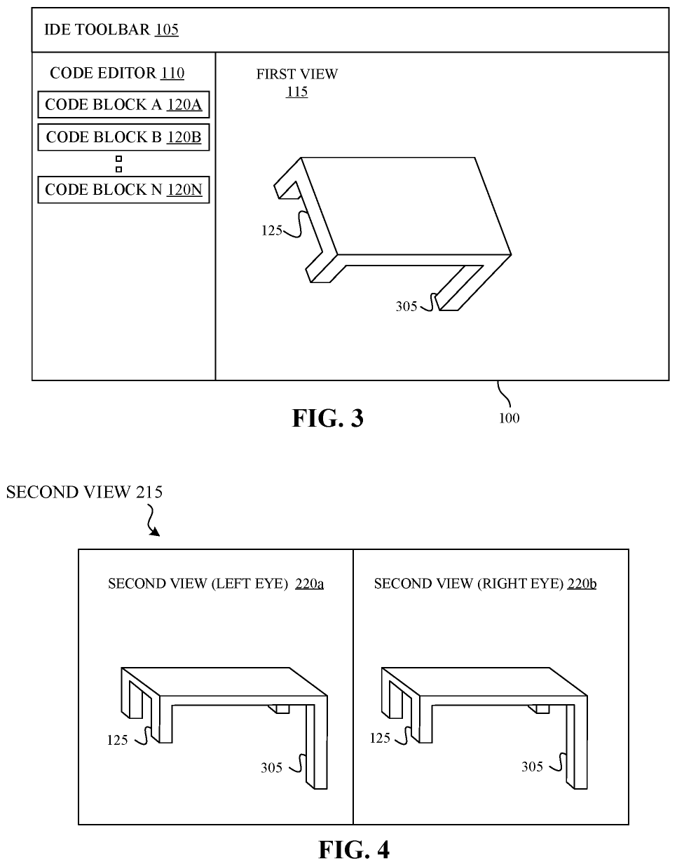

In some implementations, changes made the 3D model via the user interface 100 of the first device 10 or the user interface 200 of the device 200 are maintained or otherwise synchronized on both devices 10, 20. For example, FIGS. 3 and 4 illustrate how a change made via the user interface 100 of the first device 10 is detected and used to update the user interface 200 of the device 200.

FIG. 3 illustrates a change made to the 3D model 125 using the user interface 100 on the first device of FIG. 1. The user interface 100 enables its user to change the viewpoint or otherwise modify or interact with the 3D model 125. In some implementations, the user interface 100 is configured to receive user input that changes the appearance or positional characteristics of the 3D model 125. In this example, a user has changed one or more of code blocks 120a-n, used tools of the IDE toolbar 105 to change parameters of the 3D model 125, or graphically edited the 3D model 125 in the first view 115 to extend a leg 305 of the 3D model 125. Responsive to the input providing the change to the 3D model 125, the first device 10 provides data corresponding to the change to the second device for the second view 215, for example via link 50. The second view 215 of the 3D model is updated based on the data to maintain consistency between the 3D model 125 in the first view 115 and the second view 215.

FIG. 4 illustrates the change made to the 3D model 125 displayed in the second view 215 on the second device of FIG. 2. Leg 305 of the depicted 3D model 125 is extended to correspond to the extension of the leg 305 of the 3D model 125 in first view 115. Any changes made to the depicted 3D model 125 in the first view 115 are depicted in the 3D model 125 in the second view 215. Conversely any changes made to the 3D model 125 in the second view 215 are depicted in the 3D model 125 in the first view 115. In this way, two or more devices such as devices 10, 20 are able to simultaneously view or edit the same 3D model 125 in the same or different settings/viewing modes (e.g., monoscopically, stereoscopically, in VR, in MR, etc.).

Examples of objects represented by a 3D model 125 include, but are not limited to, a table, a floor, a wall, a desk, a book, a body of water, a mountain, a field, a vehicle, a counter, a human face, a human hand, human hair, another human body part, an entire human body, an animal or other living organism, clothing, a sheet of paper, a magazine, a book, a vehicle, a machine or other man-made object, and any other 3D item or group of items that can be identified and represented. A 3D model 125 can additionally or alternatively include created content that may or may not correspond to real world content including, but not limited to, aliens, wizards, spaceships, unicorns, and computer-generated graphics and other such items.

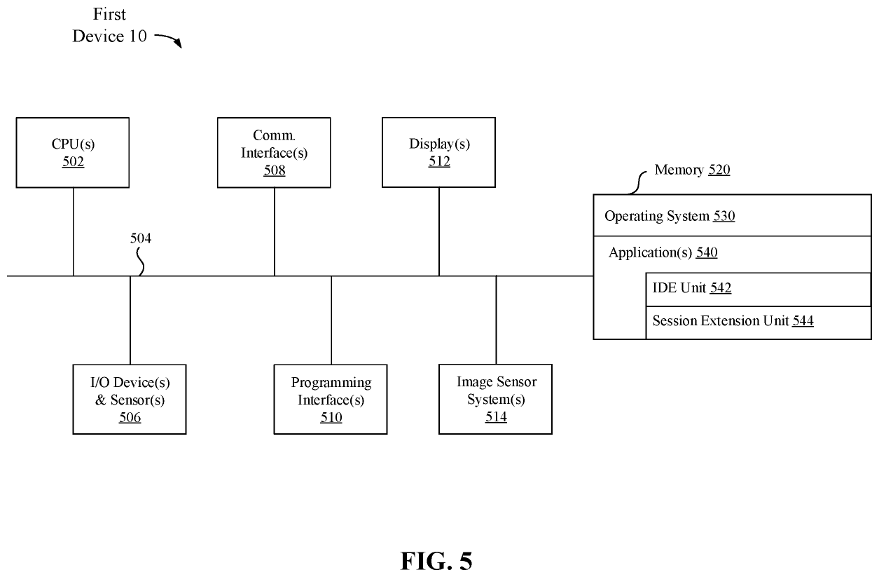

FIG. 5 illustrates device components of first device 10 according to some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the first device 10 includes one or more processing units 502 (e.g., microprocessors, ASICs, FPGAs, GPUs, CPUs, processing cores, or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 510, one or more displays 512, one or more interior or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of a touch screen, a softkey, a keyboard, a virtual keyboard, a button, a knob, a joystick, a switch, a dial, an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like. In some implementations, movement, rotation, or position of the first device 10 detected by the one or more I/O devices and sensors 506 provides input to the first device 10.

In some implementations, the one or more displays 512 are configured to present a user interface 100. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays 512 correspond to diffractive, reflective, polarized, holographic, etc. waveguide displays. In one example, the first device 10 includes a single display. In another example, the first device 10 includes a display for each eye. In some implementations, the one or more displays 512 are capable of presenting MR or VR content.

In some implementations, the one or more image sensor systems 514 are configured to obtain image data that corresponds to at least a portion of a scene local to the first device 10. The one or more image sensor systems 514 can include one or more RGB cameras (e.g., with a complimentary metal-oxide-semiconductor (CMOS) image sensor or a charge-coupled device (CCD) image sensor), monochrome camera, IR camera, event-based camera, or the like. In various implementations, the one or more image sensor systems 514 further include illumination sources that emit light, such as a flash.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and one or more applications 540. The operating system 530 includes procedures for handling various basic system services and for performing hardware dependent tasks.

In some implementations, each of the one or more applications 540 is configured to enable a user to use different devices to view or edit the same 3D model using different views. To that end, in various implementations, the one or more applications 540 includes an Integrated Development Setting (IDE) unit 542 for providing an IDE and associated user interface 100 and a session extension unit 544 for extending the viewing/editing session of the IDE to enable viewing on one or more other devices. In some implementations, the session extension unit 542 is configured to send and receive communications to the one or more other devices, for example, communications that share the 3D model 125 or changes made to the 3D model 125 via the user interface 100 or user interface 200. In some implementations, the session extension unit 542 sends communications to directly update a shared storage area on the second device with the 3D model 125 or changes made to the 3D model 125. In some implementations, the session extension unit 542 sends communications to receive changes made in the shared storage area on the second device to the 3D model so that the rendering of the 3D model via the IDE unit 542 can be updated or otherwise synchronized. In some implementations, the session extension unit 542 sends communications through a server or other intermediary device, which provides the changes to the second device.

FIG. 5 is intended more as a functional description of the various features which are present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, or firmware chosen for a particular implementation.

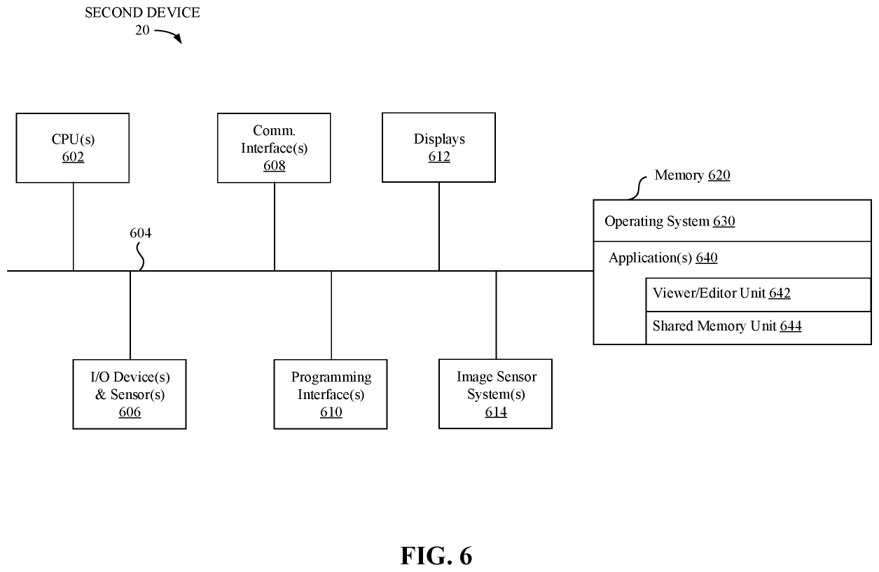

FIG. 6 is a block diagram illustrating device components of second device 20 according to some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the second device 20 includes one or more processing units 602 (e.g., microprocessors, ASICs, FPGAs, GPUs, CPUs, processing cores, or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, or the like type interface), one or more programming (e.g., I/O) interfaces 610, one or more displays 612, one or more interior or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of a touch screen, a softkey, a keyboard, a virtual keyboard, a button, a knob, a joystick, a switch, a dial, an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), or the like. In some implementations, movement, rotation, or position of the second device 20 detected by the one or more I/O devices and sensors 606 provides input to the second device 20.

In some implementations, the one or more displays 612 are configured to present a view of a 3D model that is being viewed or editing on another device. In some implementations, the one or more displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), or the like display types. In some implementations, the one or more displays 612 correspond to diffractive, reflective, polarized, holographic, etc. waveguide displays. In one example, the second device 20 includes a single display. In another example, the second device 20 includes a display for each eye. In some implementations, the one or more displays 612 are capable of presenting MR or VR content.

In some implementations, the one or more image sensor systems 614 are configured to obtain image data that corresponds to at least a portion of a scene local to the second device 20. The one or more image sensor systems 614 can include one or more RGB cameras (e.g., with a complimentary metal-oxide-semiconductor (CMOS) image sensor or a charge-coupled device (CCD) image sensor), monochrome camera, IR camera, event-based camera, or the like. In various implementations, the one or more image sensor systems 614 further include illumination sources that emit light, such as a flash.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and one or more applications 640. The operating system 630 includes procedures for handling various basic system services and for performing hardware dependent tasks.

In some implementations, the one or more applications 640 are configured to provide a user interface 200 that provides a second view 215 of a 3D object 125 being viewed or edited on the first device 10. To that end, in various implementations, the one or more applications 640 include a viewer/editor unit 642 for providing a view or editor with a view of the 3D model 125. In some implementations, the viewer/editor unit 642 is configured to use a copy of the 3D model 125 in the shared memory unit 644. In this example, the viewer/editor unit 642 monitors the shared memory unit 644 for changes, e.g., changes made to a copy of the 3D model 125 updated in the shared memory unit based on communications received from the first device 10. Based on detecting changes in the shared memory unit 644, the viewer/editor unit 642 updates the second view 215 of the 3D model provided on the second device 20. Similarly, in some implementations, changes are made to the 3D model via the second view 215 of the 3D model provided on the second device 20. The viewer/editor unit 642 stores these changes to the shared memory unit 644 so that the changes can be recognized by the first device 10 and used to maintain a corresponding/synchronized version of the 3D object 125 on the first device 125.

In some implementations, the second device 20 is a head-mounted device (HMD). Such an HMD can include a housing (or enclosure) that houses various components. The housing can include (or be coupled to) an eye pad disposed at a proximal (to the user) end of the housing. In some implementations, the eye pad is a plastic or rubber piece that comfortably and snugly keeps the HMD in the proper position on the face of the user (e.g., surrounding the eye of the user). The housing can house a display that displays an image, emitting light towards one or both of the eyes of the user.

FIG. 6 is intended more as a functional description of the various features which are present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, or firmware chosen for a particular implementation.

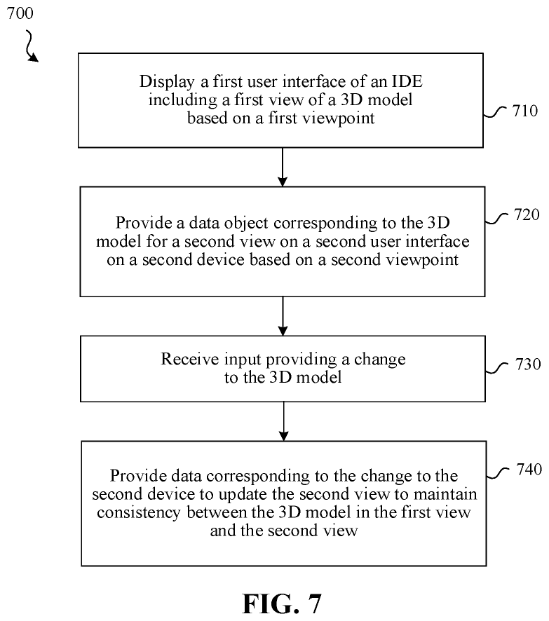

FIG. 7 is a flowchart representation of a method 700 for enabling multiple devices to interact in the same setting to view or edit the same 3D model using different views from different viewpoints. In some implementations, the method 700 is performed by a device (e.g., first device 10 of FIGS. 1-5). The method 700 can be performed at a mobile device, desktop, laptop, or server device. In some implementations, the method 700 is performed by processing logic, including hardware, firmware, software, or a combination thereof. In some implementations, the method 700 is performed by a processor executing code stored in a non-transitory computer-readable medium (e.g., a memory).

At block 710, the method 700 displays, on a first device, a first user interface of an integrated development setting (IDE) that includes a first view of a 3D model based on a first viewpoint.

At block 720, the method 700 displays a second user interface including a second view of the 3D model based on a second viewpoint different from the first viewpoint. In some implementations, the first device sends a data object corresponding to the 3D model directly to the second device without any intervening devices. In some implementation, the first devices sends a data object corresponding to the 3D model indirectly to the second device via one or more intervening devices. In some implementations, a 3D model is maintained on a server separate from the first device and second device and both the first and second devices receive data objects and other information about the 3D model from the server and communicate changes made to the 3D object back to the server. In some implementations, one or both of the first and second devices are head mounted devices (HMDs).

The second viewpoint can be different from the first viewpoint. For example, the first viewpoint can be based on a different viewing position or viewing angle than the second viewpoint. In some implementations, one of the viewpoints, e.g., the first viewpoint used for the first view, is identified based on user input and the other viewpoint, e.g., the second viewpoint used for the second view, is identified based on position or orientation of the second device in a real world setting. For example, the first viewpoint may be based on a user selecting a particular coordinate location in a 3D coordinate space for a viewpoint for the first view while the second viewpoint can be based on the position/direction/angle of an HMD second device in a real world coordinate system. Thus, in this example and other implementations, the first viewpoint is independent of device position and orientation while the second viewpoint is dependent on device position and orientation.

In some implementations, the first and second views are both monoscopic, both stereoscopic, or one of the views is monoscopic and the other is stereoscopic. In one example, one of the device, e.g., the first device, includes a single screen providing a monoscopic view of the 3D model, and the other device, e.g., the second device, includes dual screens with slightly different viewpoints/renderings of the 3D model to provide a stereoscopic view of the 3D model.

In some implementations, the first and second views are both VR, both MR, or one of the views is VR and the other is MR. In one example, the first view is based on an MR setting that combines the 3D model with content from a real world setting captured by a camera on the first device and the second view is based on a MR setting that combines the 3D model with content from a real world setting captured by a camera on the second device. In another example, real world content captured by one of the devices, e.g., by either the first device or the second device, is used to provide an MR viewing experience on both devices, e.g., both devices include the 3D model and shared real world content captured by one of the devices. In another example, one of the device, e.g., the first device, provides a VR view of the 3D model that does not include real world content and the other device, e.g., the second device, provides an MR view of the 3D model that does include real world content.

At block 730, the method 700 receives, on the first device, input providing a change to the 3D model. For example, a user of the first device, may provide keyboard input, mouse input, touch input, voice input, or other input to one of the IDE tools, code, parameters, or graphical editors to change an attribute or characteristic of the 3D model. For example, the user may change the size, color, texture, orientation, etc. of a 3D model, add a 3D model or portion of a 3D model, delete a 3D model or portion of a 3D model, etc.

At block 740, the method 700 provides data corresponding to the change to update the second view to maintain consistency between the 3D model in the first view and the second view. In some implementations, the first device sends a direct or indirect communication to the second device that identifies the change. In some implementations, the first device sends a direct or indirect communication to the second device that updates a shared memory that stores a copy of the 3D model based on the change and the second view is updated accordingly. In some implementations, the communication is sent directly from the first device to the second device via a wired or wireless connection. In some implementations, the communication is sent to the second device indirectly, e.g., via a server or other intermediary device. Such a server may maintain the 3D model and share changes made to the 3D model on other devices amongst multiple other devices to ensure consistency on all devices that are accessing the 3D model at a given time.

In some implementations, changes are consolidated or coalesced to improve the efficiency of the system. For example, this can involve detecting multiple changes between an initial state and a final state of the 3D model and providing data corresponding to differences between the initial state and the final state of the 3D model. If the 3D model is first moved 10 units left and then moved 5 units right, a single communication moving the 3D model 5 units left can be sent. In some implementations, all changes receives within a predetermined threshold time window (e.g., every 0.1 seconds, every second, etc.) are consolidated in this way to avoid overburdening the processing and storage capabilities of the devices.

In some implementations, a link is established between the first device and the second device to enable simultaneous display of changes to the 3D object on the first device and second device. In some implementations, the link is established via an operating system (OS)-level service call. Such a link can be wired or wireless. The link may also invoke or access a shared memory on the second device. A daemon can map this shared memory into its process space so that it becomes a conduit for the first device to seamlessly link the second device to provide the shared viewing/editing experience.

A link between devices can be used to enable a shared viewing/editing session between the devices. In some implementations, the user experience is enhanced by facilitating the creation of such a session and/or the sharing of the 3D model within such a session. In some implementations, a wireless or wired connection or other link between the first device and the second device is automatically detected by the first device. Based on the detecting of the wireless or wired connection, the first device initiates the shared viewing/editing session. In some implementations, the first device sends a communication to the second device to automatically launch the second user interface on the second device. This can involve launching a viewer/editor application on the device and establishing a shared memory on the second device that can be accessed both by the launched viewer/editor application as well as directly by communications from the first device.

The link between devices that facilitates the shared viewing/editing experience can additionally be used to enhance the experience on one of the devices with functionality that is only available on the other device. For example, the first device may have Internet access and thus access to an asset store that is not available to the second device. However, as the user edits on the second device, he or she can access the assets available on the asset store via the link. The user need not be aware that the first device, via the link, is being used to provide the enhanced user experience.

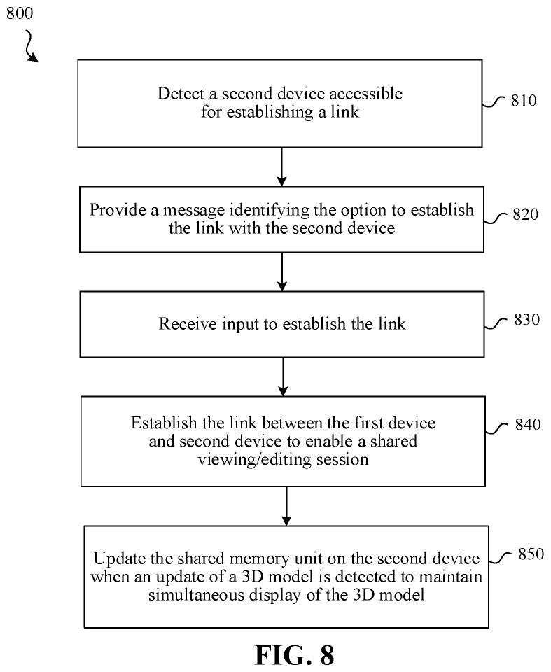

In some implementations, a user-friendly process is used to establish as shared viewing/editing session, as described with respect to FIG. 8. FIG. 8 is a flowchart representation of a method 800 for establishing a link between a first device and a second device based on detecting the second device and user input. In some implementations, the method 800 is performed by a device (e.g., first device 10 of FIGS. 1-5). The method 800 can be performed at a mobile device, desktop, laptop, or server device. In some implementations, the method 800 is performed by processing logic, including hardware, firmware, software, or a combination thereof. In some implementations, the method 800 is performed by a processor executing code stored in a non-transitory computer-readable medium (e.g., a memory).

At block 810, the method 800 detects a second device accessible for establishing a link. In some implementations this involves detecting that another device has been connected via a USB or other cable. In some implementations this involves detecting that a wireless communication channel has been established between the devices. In some implementations, this may additionally or alternatively involve recognizing that the connected device is a particular device, type of device, or device associated with a particular user, owner, or account.

At block 820, the method 800 provides a message identifying the option to establish the link with the second device. A text, graphical, or audio message is presented, for example, asking whether the user would like to extend the current viewing/editing session to the other detected device.

At block 830, the method 800 receives input to establish the link and, at block 840, the method 800 establishes the link between the first device and the second device to enable a shared viewing/editing session. In some implementations, the first device, based on receiving the input, sends a communication to the second device to automatically launch a second user interface on the second device and connect the second user interface to the current editing session. Establishing the link can involve initiating a shared memory on the second device and copying the 3D model to the shared memory. Establishing the link can involve launching a viewer/editor on the second device and instructing the second device to access a copy of the 3D model in the shared memory for display in a second view.

At block 850, the method 800 updates the shared memory on the second device when an update of the 3D model is detected on either the first device or second device to maintain simultaneous display of the 3D model. Both the first device and second device can be configured to update the shared memory based on changes to the 3D model on their own user interfaces and to periodically check the shared memory for changes made by the other device to be used to update their own user interfaces.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a first device with one or more processors and a computer-readable storage medium:
displaying, on the first device, a first user interface of a software development setting, the first user interface comprising a first view of a 3D model based on a first viewpoint, wherein a second user interface on a second device comprises a second view of the 3D model based on a second viewpoint, the second viewpoint is different from the first viewpoint, and the second device is a head mounted device (HMD);
receiving, on the first device, input providing a change to the 3D model; and
responsive to the input providing the change to the 3D model, providing data corresponding to the change, wherein the second view of the 3D model is updated based on the data to maintain consistency between the 3D model in the first view and the second view.

2. The method of claim 1 further comprising:
providing a data object corresponding to the 3D model directly from the first device to the second device; and
providing the data corresponding to the change directly from the first device to the second device.

3. The method of claim 1 further comprising:
providing a data object corresponding to the 3D model indirectly from the first device to the second device; and
providing the data corresponding to the change indirectly from the first device to the second device.

4. The method of claim 1, wherein the 3D model is maintained on a server separate from the first device and second device, wherein a data object corresponding to the 3D model and the data corresponding to the change are provided by the server to the second device.

5. The method of claim 1, wherein the first viewpoint is:
based on a different viewing position than the second viewpoint; or
based on a different viewing angle than the second viewpoint.

6. The method of claim 1, wherein:
the first view is monoscopic and the second view is stereoscopic;
the first viewpoint is identified based on user input and the second viewpoint is identified based on position or orientation of the second device in a real world setting; or
the first viewpoint is independent of device position and orientation and the second viewpoint is dependent on device position and orientation.

7. The method of claim 1, wherein the first view or second view is based on a virtual reality (VR) setting comprising the 3D model.

8. The method of claim 1, wherein the first view is based on a mixed reality (MR) setting that combines the 3D model with content from a real-world setting captured by a camera on the first device or the second device.

9. The method of claim 1 further comprising establishing a communication link between the first device and the second device to enable synchronized display of changes to the 3D object on the first device and second device.

10. The method of claim 9, wherein the communication link is established via an operating system (OS)-level service call.

11. The method of claim 1, wherein a shared memory on the second device comprises a copy of the 3D model, wherein providing the data corresponding to the change comprises updating the copy of the 3D model in the shared memory on the second device based on the data.

12. The method of claim 1 further comprising:
detecting a wireless or wired connection between the first device and the second device; and
based on the detecting of the wireless or wired connection, sending a communication to the second device to automatically launch the second user interface on the second device.

13. The method of claim 1 further comprising:
detecting a wireless or wired connection between the first device and the second device;
based on the detecting of the wireless or wired connection, providing, on the first user interface, an option to link the second device into a current editing session of the user interface;
receiving input selecting the option; and
based on receiving the input, sending a communication to the second device to automatically launch the second user interface on the second device and connect the second user interface to the current editing session.

14. The method of claim 1, wherein providing data corresponding to the change comprises:
detecting multiple changes between an initial state and a final state of the 3D model; and
providing data corresponding to differences between the initial state and the final state of the 3D model.

15. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
displaying, on a first device, a first user interface of a software development setting, the first user interface comprising a first view of a 3D model based on a first viewpoint, wherein a second user interface on a second device comprises a second view of the 3D model based on a second viewpoint, the second viewpoint is different from the first viewpoint, and the second device is a head mounted device (HMD);
receiving, on the first device, input providing a change to the 3D model; and
responsive to the input providing the change to the 3D model, providing data corresponding to the change, wherein the second view of the 3D model is updated based on the data to maintain consistency between the 3D model in the first view and the second view.

16. The system of claim 15, wherein the 3D model is maintained on a server separate from the first device and second device, wherein the server is configured to provide a data object corresponding to the 3D model and the data corresponding to the change to the second device.

17. The system of claim 15, wherein the first view is monoscopic and the second view is stereoscopic.

18. A non-transitory computer-readable storage medium, storing program instructions computer-executable on a computer to perform operations comprising:
displaying, on a first device, a first user interface of a software development setting, the first user interface comprising a first view of a 3D model based on a first viewpoint, wherein a second user interface on a second device comprises a second view of the 3D model based on a second viewpoint, the second viewpoint is different from the first viewpoint, and the second device is a head mounted device (HMD);
receiving, on the first device, input providing a change to the 3D model; and
responsive to the input providing the change to the 3D model, providing data corresponding to the change, wherein the second view of the 3D model is updated based on the data to maintain consistency between the 3D model in the first view and the second view.

19. The non-transitory computer-readable storage medium of claim 18, wherein the first viewpoint is based on a different viewing position or viewing angle than the second viewpoint.

20. The non-transitory computer-readable storage medium of claim 18, wherein the first viewpoint is independent of device position and orientation and the second viewpoint is dependent on device position and orientation.
